(19) United States
(12) Patent Application Publication
(10) Pub. No.: US 2015/0310213 A1
(43) Pub. Date: Oct. 29, 2015

(54) ADJUSTMENT OF PROTECTION BASED ON PREDICTION AND WARNING OF MALWARE-PRONE ACTIVITY

(71) Applicant: Microsoft Corporation, Redmond, WA (US)

(72) Inventors: Royi Ronen, Tel Aviv (IL); Elad Ziklik, Modi'in (IL); Corina Feuerstein, Herzilya (IL); Tomer Brand, Hod Hasharon (IL)

(73) Assignee: Microsoft Corporation, Redmond, WA (US)

(21) Appl. No.: 14/265,308

(22) Filed: Apr. 29, 2014

(51) Int. Cl. G06F 21/57; G06F 21/50

(52) U.S. Cl. CPC G06F 21/57; G06F 21/50

(57) ABSTRACT

Disclosed herein is a system and method for a system and method for determining whether the protection level of a protection system is appropriate for the way the user of a computing system is using the device. The protection system monitors the user's activity while they are using the various applications on the device. The protection system identifies an activity record that is the most similar to the user's activity and compares the current protection level with the associated record's protection level. The protection system may change the protection level when the user's protection level and the associated record's protection level are different.

### TECHNICAL FIELD

This description relates generally to automatically identifying whether a current protection level is appropriate based on the user's activity.

### BACKGROUND

Typically, computer systems and devices are protected by anti-malware software and other protection systems. These systems work by scanning incoming files and comparing the signatures of the files to known instances of malware that have been identified by malware researchers. Additionally, many protection systems impose additional controls on the user's activity to assist in preventing the downloading or opening of malicious material. Typically this is found in an internet browser where the user or administrator sets a protection level for the browser. This protection level defines what internet sites can be accessed and also can cause a number of warnings to be presented to the user simply because the user went to a site that requires information from the local system or access to the local system.

Users of these systems are constantly bombarded with these warnings or the inability to have certain features readily available to them without having to go through the tedious process of handling the warning messages and possibly reloading the particular site. These warnings are generated for the users regardless of whether the site in question is malicious as they are only managed by the preset protection level. The user can change the protection level to reduce the protection level, but this may in the end not be advisable for the user.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for determining whether the protection level of a protection system is appropriate for the way the user of a computing system is using the device. The protection system monitors the user's activity while they are using the various applications on the device. This monitored activity is converted to an activity record which is then compared against a number of activity records for other users across multiple different devices and systems. The protection system identifies at least one record in an activity database that is the most similar to the monitored activity of the user. The protection system then compares the associated risk score or protection level for the selected activity record and the current protection level for the user. If there is a difference between the current protection level and the level for the selected record, the protection system can adjust the protection level for the user to match the selected record. In this manner the protection level for the system can adjust dynamically in response to the user's actual activity as opposed to simply remaining static throughout. Thus, a user engaging in riskier behavior, be it internet browsing or some other activity, can gradually have the protection level increased. Whereas a user engaging in safer behavior may gradually have their protection level decreased and thus may benefit from fewer warnings being displayed to them.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is as block diagram illustrating components of a protection system having proactive protection leveling according to one illustrative embodiment.

FIG. 2 is a flow diagram illustrating a process for providing variable protection levels according to one illustrative embodiment.

FIG. 3 is a block diagram illustrating components used for generating a collaborative activity database according to one illustrative embodiment.

FIG. 4 is a flow diagram illustrating a process to generate the activity database according to one illustrative embodiment.

FIG. 5 illustrates a component diagram of a computing device according to one embodiment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

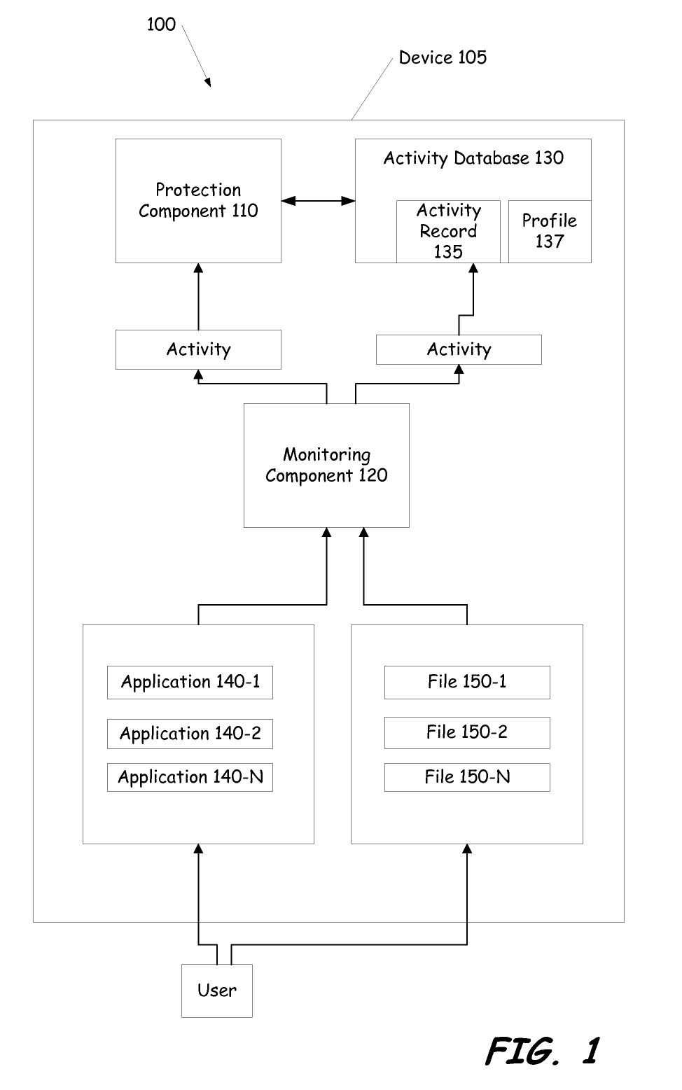

FIG. 1 is a block diagram illustrating a protection system 100 for providing proactive protection leveling of a computing system according to one illustrative embodiment. System 100 includes protection component 110, monitoring component 120, activity database 130, applications 140, and files 150. The components of system 100 may be on a single machine or device, such as device 105 that is intended to be protected or may be distributed in a service oriented environment. The machine or device 105 to be protected may include a personal computer, a tablet computer, a mobile phone, a television, a gaming console, or any other machine or device with which a user interacts with in a manner that could cause harmful content to appear on the device or allow unauthorized access to the machine or device.

Protection component 110 is in one embodiment, a component of the system that protects the system from hostile files and activity such as malware, viruses and trojans. Protection component 110 is configured to respond to the various activities of the user and enforce one or more policies in order to protect the system. For, example the protection component 110 may scan each file and site that is encountered to determine whether the particular site contains malware. If malware is detected the protection component 110 may quarantine the suspect file, repair the suspect file or otherwise flag the file for further analysis. In some embodiments the protection component 110 may allow the user access to certain sites and block access to other sites (e.g. whitelists and blacklists). In some embodiments the protection component is a component of another application such as an internet browser.

The protection component 110 is further configured to allow for the varying the strength or intrusiveness of the protection. The level of protection offered by the protection component 110 is referred to herein as the protection level. A protection level may be applied to the entire device 105 or to portions of the device such as an application running on the device 105 (e.g. an internet browser). In an alternative embodiment, the protection level may be applied on a user level. This could occur where the user's overall behavior across multiple devices illustrates unsafe or questionable actions. Depending on how the protection component 110 is configured (either by an administrator or by a protection policy) the protection component 110 may allow for the user to have some control over the level of protection provided by the protection component 110. In this configuration the protection component 110 can, for example, be set for a medium or intermediate level of protection. However, the user could select a higher level of protection or a lower level of protection that falls within the levels permitted by the protection policy. The protection component 110 may be configured to have different protection levels applied for different users of the system. For example, in a household where parents and children share the same machine, or in a corporation where different users share the same machine. In this approach a higher level of protection may be desired for an internet browser when it is used by children, but a lesser level is desired when used by adults.

The protection component 110 is configured to receive data from the monitoring component 120 indicative of the activities that the user has engaged in. The protection component 110 uses this data to determine if the current level of protection provided by the protection component 110 is appropriate for the user. The protection component 110 takes the data from the monitoring component 120 and compares it with data contained in the activity database 130. The protection component 110 attempts to find in the activity database 130 an activity record 135 that is most similar to the current activity of the user as reported by the monitoring component. The protection component 110 uses a similarity measure to determine the similarity between the current activity and the activity records. In one embodiment the similarity measure is the Jacard similarity measure. In another embodiment a cosine similarity measure is used. However, any similarity measure may be used to determine the similarity between an activity record 135 and the current user's activity.

The protection component 110 compares the protection level associated with the closest, i.e. most similar, activity record 135 with the current protection level. If the current protection level and the associated level for the similar activity are the same then the protection component 110 does not change the current protection level. If the current protection level is lower than the protection level for the associated record, the protection component 110 may change the protection level to match the protection level with the protection level of the associated activity record 135. If the current protection level is higher than the protection level of the associated record, the protection component 110 may change the current protection level to the lower protection level of the associated record. In some cases more than one activity record 135 may be determined to be similar to the user's current activity. In this instance the protection component 110 may consider the average of the protection levels for the activity records as the protection level for the comparison. Alternatively, the protection component 110 may select the activity record 135 with the highest level of protection as the protection level for the comparison. If a risk score is used the protection component 110 converts the identified risk score to a corresponding protection level for use in the comparison. This may be accomplished by looking in a table to determine what risk levels correspond to what protection levels used by the protection component 110.

In some embodiments the protection component 110 is further configured to consider additional data within the monitored activity record 136 in determining the protection level that is to be applied to the system. For example, the protection component 110 may identify that different levels of protection are required at different times of the day or even on different days. This could occur for example when a particular machine is used by an entire family. In this example, during the day when children are at school the protection level could be lowered based on the monitored activity showing that from 9 am to 3 pm the activity patterns are more similar to low risk activities, such as from an adult using a machine for work. However, from 3 pm to 8 pm the protection component 110 may recognize that the activities are more closely similar to higher risk activities as children may not be as careful in adults in their use of the machine thereby necessitating a higher level of protection during those time periods. The protection component 110 can vary the protection level of the system for other reasons as well based on different data contained in the monitored activity.

In some embodiments the protection component can further consider external rules or information in the determination to adjust the protection level. For example in some instances it may be known that a particular web site or type of web site is going to be compromised (e.g. from a hacker attack). The protection component 110 may in this instance raise the protection level for the system when it is known that the user typically visits those types of web sites. The raised protection level may only remain elevated during the time period of the anticipated corruption of the web site. In another embodiment, different protection levels may be applied to activity for which there is no history with. For example, new applications or web sites may be subjected to higher protection levels as their safety is not yet known. In this embodiment the site would only be accessible through the lowest level of protection until such time as the site has been verified as safe, such as through time passing with no reports or an analysis of the site being completed.

In some embodiments the protection component 110 is configured to differentiate two or more users who use the same machine or device but are not otherwise identifiable from each other through for example, a user login. In this embodiment when the beginning of an activity pattern matches a known activity pattern for a particular user, the protection component 110 can adjust the protection level to the level associated with that particular user.

In some embodiments the protection component 110 automatically changes the protection level in response to the comparison with the similar activity records. The ability to automatically change the protection can be defined in a policy that is either provided by an administrator or provided by the user to the protection component 110. In some embodiments the protection system will inform the user of the change in the protection level through, for example, a display or dialog on the user interface of the system. The user may be given the option to accept or reject the change in protection level. In some embodiments increases in protection level are done automatically, while reductions in the protection level would require the user to positively accept the change in the protection level. Again the thresholds for the notification and acceptance of the change may be defined in a policy.

Monitoring component 120 is in one embodiment a component of the system that monitors the user's 101 activities on the associated device. Monitoring component 120 observes the user as they interact with the applications and files on the device. Monitoring component 120 may also observe the behavior of the device in response to the user's activity. In such an instance the monitoring component 120 may observe where a particular file is saved and that the act of saving the file occurred as the result of the application being closed. In other embodiments the monitoring component 120 may detect that a particular website that is visited caused a certain modification to an underlying file on the device. In some embodiments every action that the user makes is tracked and monitored by the monitoring component. In other embodiments only selected portions of the user's actions are tracked by the monitoring component. For example, the monitoring component 120 may only monitor activity by the user when the user interacts with applications, websites and files that are located outside of a local network where the device resides. In other embodiments the monitoring component 120 may only monitor those activities that occur on non-secure channels, such as internet sites that do not make use of the HTTPS protocol. In yet another embodiment the monitoring component 120 may only monitor the user's activity for periods of time. These periods of time can vary according to a policy that is set by an administrator. In this way the monitoring component 120 can capture activity at various times without the user being able to predict what times or what activities will cause the monitoring to occur. In yet another embodiment the monitoring component 120 will begin monitoring in response to the user performing a predetermined activity. For example monitoring can be started in response to the user downloading or installing a new application to the system or device, or even when simply browsing to web sites that are known to be frequently compromised. Other activities that could cause the monitoring component 120 to begin monitoring activities could be in response to a change being made to a system registry or a detection of a malware event. In the embodiment where a malware event was detected the monitoring component 120 may report back the activity that occurred for a predetermined period of time prior the detection of the malware event. This allows for the recording of the activities that occurred prior to the event that may be useful in finding other similar activity records. The mere detection of a malware event is not necessarily a reason for changing the protection level, unless there are further indications that the activity prior to the malware detection is indicative of the need.

The monitoring component 120 is further configured in some embodiments to report the activity of the user as well as the associated protection level to a centralized system. In this manner the associated activity database 130 can be updated with information related to a large number of users such that better similarity matches can be made and the protection component 110 can make more informed decisions and/or recommendations on the appropriate protection level.

Activity database 130 is in one embodiment a database that stores a plurality of different activity patterns along with a corresponding indication of risk or an optimal protection level for that activity pattern as an activity record 135. The plurality of different activity patterns are activity patterns that have been acquired from a plurality of different users that use different versions of the system on a number of different devices. In some embodiments the activity database 130 is located remote from the other features of the system such that the protection component 110 communicates with the activity database 130 through a network connection. In this embodiment the need to constantly maintain or update the activity database 130 on the local device is significantly reduced as management of the activity database 130 is handled at a centralized location. The activity database 130 may also store or maintain the various reports made by the monitoring component 120 for use by the protection component 110 in setting the protection level. The records associated with the user of the system can be used to create a profile 137 for the user. Additionally, the activity database 130 may contain different profiles for different users of the system. These profiles may be shared with other users or administrators.

The information that is stored in the activity database 130 can be any characteristics of an activity that can be, measured, tracked or used to determine the similarity of the monitored activities of the user with the stored activities of other users. In some embodiments the information stored may be adjusted or modified based on characteristics of activity that an administrator finds informative in making a decision as to the desired level of protection. Each entry however, should include either a risk score or an optimal protection level indication. A risk score is a representation or measurement of a risk for an activity pattern without associating a particular protection level to the record. This allows for risk to be measured independent of how a particular organization or user chooses to respond to that risk. This ensures that the protection component 110 receives information relevant to selecting a protection level for the system based on the similarity calculations.

Applications 140-1, 140-2 and 140-N (collectively referred to as application 140) are applications that used by the device in the normal operation of the device. Application can include applications such as internet browsers, web or cloud applications, word processing, spreadsheets, database applications, email programs, or any other type of application that is present or used by the device. Each of the applications has the potential to drive an increase or decrease in the perceived risk to the overall device. Internet browsers are applications that are more likely than other applications to open a machine to vulnerabilities. In some embodiments, applications can include web pages or web sites that are accessed by the user in addition to web based applications. Web sites and such can also be considered a combination of files and applications.

Files 150-1, 150-2, and 150-N (collectively referred to as file 150) are files that are stored on or accessed by the device in the ordinary course of the user using the associated applications and/or the device. Additionally files 150 include files that are downloaded from a network onto the device while the device is currently in use. All of the files 150 that are on the device will have at one time or another been examined for risks by the protection component 110. The point in time when the files are analyzed by the protection component 110 is controlled by the underlying protection logic of the protection component 110.

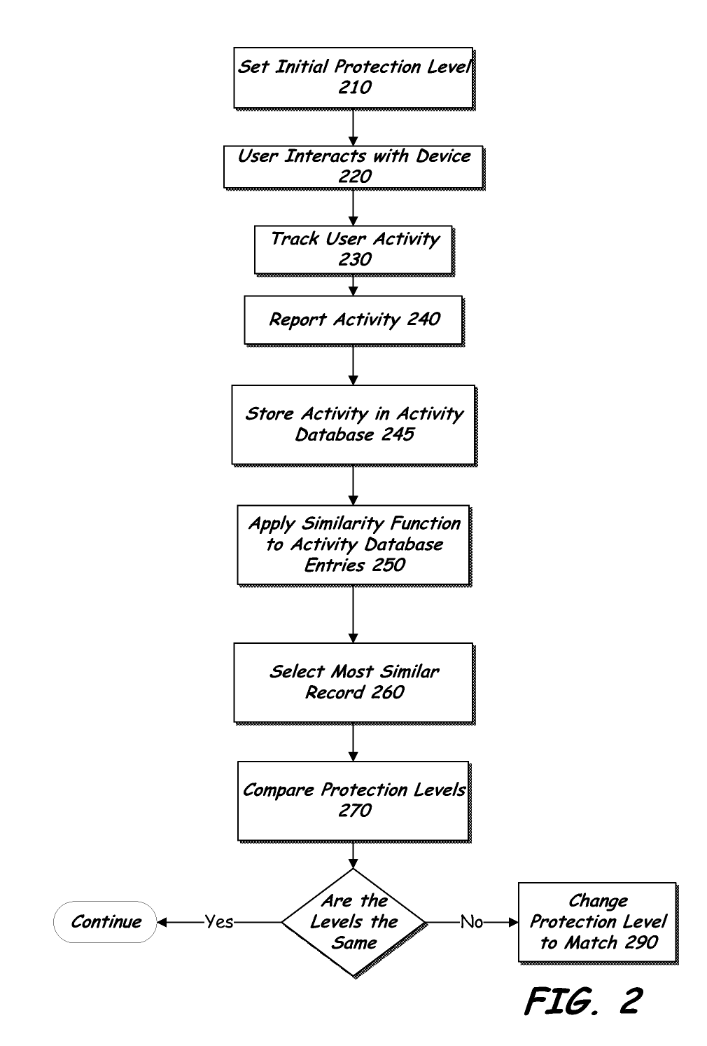

FIG. 2 is a flow diagram illustrating a process for providing variable protection levels according to one illustrative embodiment. The process begins by setting an initial protection level. This is illustrated at step 210. In one embodiment the protection component 110 sets an initial protection level for the system at a middle or average level. In some embodiments the protection level may be set to a high protection level. In some embodiments the protection level may be determined by a policy that has been generated by an administrator. As discussed previously, the policy that is applied initially may vary depending on the profile of the user of the device.

After the initial protection level has been set for the device the user interacts with the various applications that are associated with the device. This is illustrated at step 220. At this step the user may open files, save files, use an internet browser or perform any number of actions that are available. As each of the actions is performed by the user the monitoring component 120 tracks the actions and generates a history and profile for the user. This tracking is illustrated at step 230. In some embodiments the monitoring component 120 does not continuously monitor the user's actions. The monitoring component 120 may initiate random monitoring of the user, or may initiate monitoring in response to a specific event occurring (e.g. visiting a particular website, downloading a particular type of file, detecting a malware event, etc.). In other embodiments the monitoring component 120 may perform passive monitoring. When using the passive monitoring approach, the monitoring component 120 is monitoring the user's actions but not recording the actions to the activity database 130 or reporting to the protection component 110 until a predefined event has occurred. Once the predefined event is detected the monitoring component 120 can capture the activity from a predefined period in the past and report this activity information out.

The monitoring component 120 reports or provides the tracked activity information to the protection component 110 at step 240. The monitoring component 120 may also store the tracked activity information to the activity database 130 at step 245. Storing the tracked activity information in the activity database 130 allows for the development of a user profile, such as profile 137, of activity as well as allowing for the protection component 110 to retrieve historical tracking information related to the user's activities for enhanced analysis and protection modification.

The protection component 110 takes the user's tracked activity that was received from either the monitoring component 120 directly or from the activity database 130 and attempts to find an activity record 135 in the activity database 130 that is the most similar to the user's tracked activity. This is illustrated at step 250. The protection component 110 applies a similarity measure to the user's tracked activity and each of the records in the activity database 130. In one embodiment a Jacard similarity measure is applied. In another embodiment a cosine similarity measure is applied. However, any similarity function can be applied to the user's activity and the activity records in the activity database 130. The similarity measure is applied to at least a portion of the information contained in the activity record 135. An administrator can determine which information (features) in the activity records is most informative or predictive of overall risk. In some embodiments the administrator can employ a feature selection algorithm to assist in identifying those features of the activity record 135 are more valuable than others. By using feature selection the large amount of data that may be present in the activity record 135 may be reduced to a small number of features for analysis by the protection component 110. However, other method of selecting an activity record 135 may be used.

Once the similarity between the user's activity and the activity records in the activity database 130 have been determined the protection component 110 selects at least one of the activity records for comparison with the current protection level. This is illustrated at step 260. The protection component 110 may select at this step the activity record 135 that is the closest (i.e. most similar) to the user's activity record 135 as the activity record 135 for comparison. Alternatively, the protection component 110 may select the activity record 135 that is within a predetermined distance from the user's activity record 135 that has the highest level of protection or indicated risk as the activity record 135 for comparison. In another embodiment the protection component 110 may select multiple activity records for comparison. Again other methods of selecting the activity records may be used.

Following the selection of the activity record 135 for comparison, the protection component 110 compares the associated protection level for the record with the currently assigned protection level. This is illustrated at step 270. If the activity record 135 lists a specific protection level then that level is specifically compared with the current assigned level. If the activity record 135 lists a risk score, then the protection component 110 determines an appropriate protection level for the risk score and then proceeds to compare the determined protection level with the current protection level. This may be achieved by comparing the risk score from the record to a table that converts the risk score to a protection level based on the protection levels used by the system.

The protection component 110 then determines if the current protection level should be changed based on the comparison. This is illustrated at step 280. If the comparison indicated that the current protection level and the protection level in the activity record 135 are the same or equivalent, the protection component 110 will not change or otherwise modify the protection level.

If the comparison indicated that the current protection level is lower than the protection level of the activity record 135 the protection component 110 may raise the protection level. The protection component 110 may cause a dialog to appear on the user interface informing the user that their activity indicates that they may be at greater risk and that the protection level should be increased. The user may be given the option to increase the protection level. Alternatively the protection level could be automatically increased. The user may or may not be informed of this increase via a dialog. The increase in the protection level may be mandated by a policy that has been placed on the machine by an administrator.

If the comparison indicated that the current protection level is higher that the protection level of the activity record 135 the protection component 110 may lower the protection level. The protection component 110 may cause a dialog to appear on the user interface informing the user that their activity is less risky and a lower level of protection could be employed. The user would then be prompted via the dialog to accept the lowering of the protection level. The dialog may inform the user of the level that the protection can be reduced to, or may simply allow the user to lower the protection. In lowering the protection level, the protection component 110 can incrementally lower the protection level over time as opposed to dropping the protection level all at once. In some embodiments the ability to lower the protection level is determined by a policy. The user may only be able to lower the protection level to a certain level regardless of whether the protection system determines that the level could be lower.

Alternatively, the protection component 110 may send a message to an administrator that a particular machine's profile indicates that the protection level may be lowered or should be increased. In this embodiment the administrator makes the decision as to whether to increase or decrease the protection level for a particular machine or user. This change in the protection level is illustrated at step 290. Alternatively, the administrator could make other decisions with regards to the particular machine such as changing the user's permissions to networked or local features or placing the device in isolation.

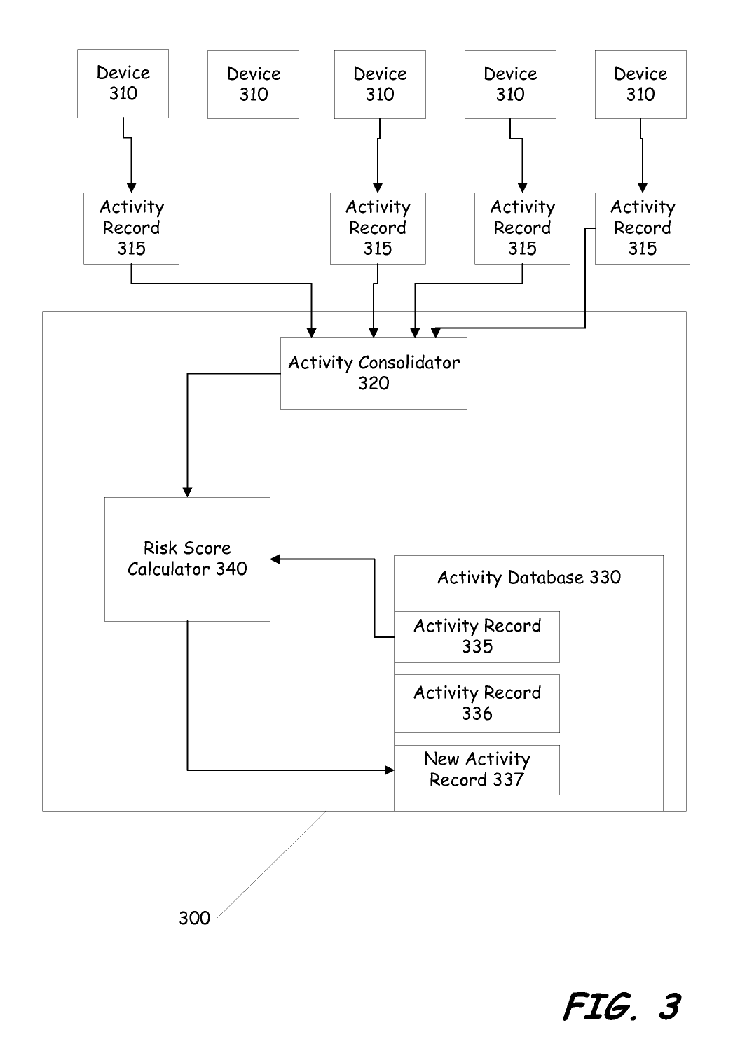

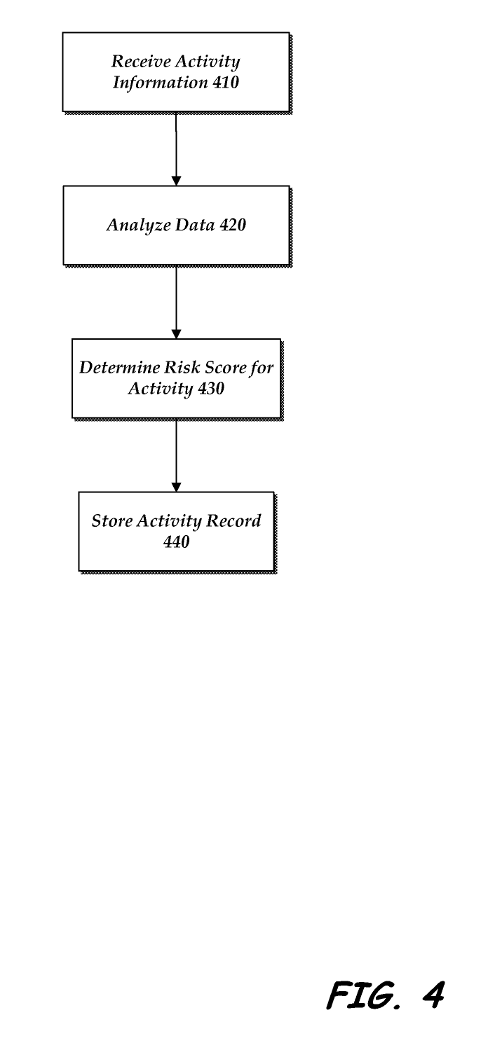

FIG. 3 is a block diagram illustrating components used for generating a collaborative activity database according to one illustrative embodiment from multiple users of the system according to one illustrative embodiment. FIG. 4 is a flow diagram illustrating a process for collaborating among a variety of users of the system to generate the activity database according to one illustrative embodiment. For purposes of this discussion FIGS. 3 and 4 will be discussed together.

The collaborative collection system 300 of FIG. 3 includes a plurality of machines and or devices 310 that all implement the protection and monitoring system discussed above. However in other embodiments other or different protection systems could also provide information to the system. Each machine 310 reports to an activity consolidator 320 activity that is collected by the corresponding monitoring component 120 operating on the associated machine 310 as a monitored activity record 315. This collection or receipt of the activity record 315 information is illustrated at step 410.

The activity consolidator 320 takes each received activity record 315 and analyzes the data to ensure that the data is in the correct format and it includes enough information to be useful for comparison by a protection component, such as protection component 110, at a later time. This is illustrated at step 420.

Once the received activity record 315 has passed through the initial analysis, the activity consolidator 320 identifies the protection level or risk score that is associated with the received activity record 315. If the activity record 315 already includes a risk score as opposed to a protection level the record is passed to the activity database 330 to be stored as a new activity record in the activity database 330. However, if the activity record 315 includes a protection level, the activity consolidator 320 passes the received activity record 315 to a risk score calculator 340 to determine a risk score for the activity record 315. This is illustrated at step 430.

At step 430 the risk score calculator 340 determines the risk score that should be associated with the received activity record 315. In one embodiment the risk score calculator 340 uses a look-up table that associates a received protection level with a predetermined risk score. However, because various activities that are similar may have different protection levels due to different risk policies of the originating systems, the risk score calculator 340 can in some embodiments determine a risk score for the activity record 315 that is received. This can occur because one organization or system is less risk adverse than another system where one organization would rate a hypothetical risk score of 50 as a low risk and assign a corresponding protection level to the system. Whereas a different organization may assign the same risk level a medium or high risk and set the protection level accordingly. In one embodiment, the risk score calculator 340 applies a similarity measure to the received record 315 and to the activity records already present in the activity database 330. This is similar to the approach used in FIG. 2 above for identifying the most similar activity record 135. The activity record 335 in the activity database 330 that is most similar to the received record 315 is identified. From this record 335 the risk score of that record 335 is assigned to the received record 315. In some embodiments the assigned risk score for the record 315 may be adjusted based on the closeness of the received record 315 to the matched activity record 335. In other embodiments the two closest activity records 335 and 336 in the activity database 340 are selected for determining the risk score. In this approach the two records 335, 336 that are selected are the two closest activity records having similarity measures that place the received record 315 at a vector that lies between the vectors for the two activity records 335, 336. Again the risk score would be assigned to the received record 315 based on its distance from each of the activity records 335, 336 and their relative assigned risk scores.

Once the risk score has been determined for the received record 335, the record is stored in the activity database 330 as a new activity record 337. This is illustrated at step 440. The activity database 330 is then provided to any protection component 110 that requests the activity database 330. This is illustrated at step 440.

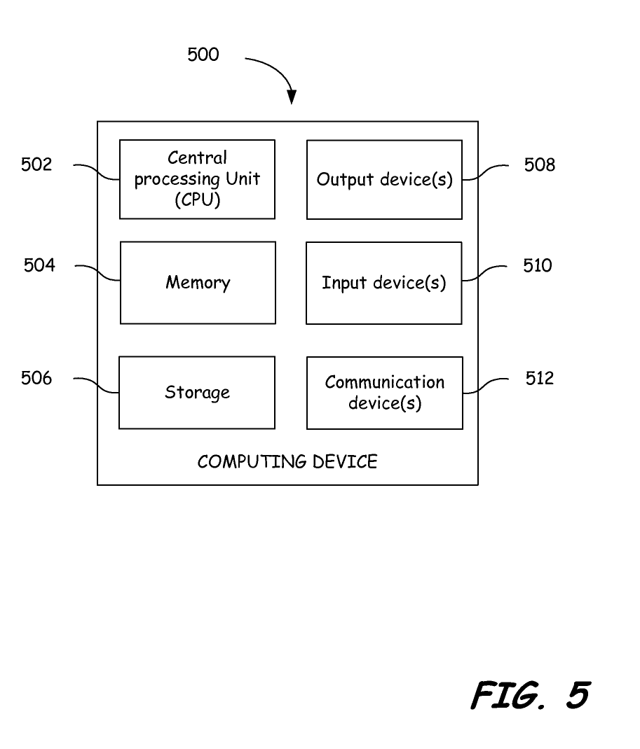

FIG. 5 illustrates a component diagram of a computing device according to one embodiment. The computing device 500 can be utilized to implement one or more computing devices, computer processes, or software modules described herein. In one example, the computing device 500 can be utilized to process calculations, execute instructions, receive and transmit digital signals. In another example, the computing device 500 can be utilized to process calculations, execute instructions, receive and transmit digital signals, receive and transmit search queries, and hypertext, compile computer code, as required by the system of the present embodiments. Further, computing device 500 can be a distributed computing device where components of computing device 500 are located on different computing devices that are connected to each other through network or other forms of connections. Additionally, computing device 500 can be a cloud based computing device.

The computing device 500 can be any general or special purpose computer now known or to become known capable of performing the steps and/or performing the functions described herein, either in software, hardware, firmware, or a combination thereof.

In its most basic configuration, computing device 500 typically includes at least one central processing unit (CPU) 502 and memory 504. Depending on the exact configuration and type of computing device, memory 504 may be volatile (such as RAM), non-volatile (such as ROM, flash memory, etc.) or some combination of the two. Additionally, computing device 500 may also have additional features/functionality. For example, computing device 500 may include multiple CPU's. The described methods may be executed in any manner by any processing unit in computing device 500. For example, the described process may be executed by both multiple CPU's in parallel.

Computing device 500 may also include additional storage (removable and/or non-removable) including, but not limited to, magnetic or optical disks or tape. Such additional storage is illustrated in FIG. 5 by storage 506. Computer storage media includes volatile and nonvolatile, removable and non-removable media implemented in any method or technology for storage of information such as computer readable instructions, data structures, program modules or other data. Memory 504 and storage 506 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 500. Any such computer storage media may be part of computing device 500.

Computing device 500 may also contain communications device(s) 512 that allow the device to communicate with other devices. Communications device(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 500 may also have input device(s) 510 such as keyboard, mouse, pen, voice input device, touch input device, etc. Output device(s) 508 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A protection system for a computing device comprising:
a monitoring component configured to monitor activity performed on the computing device to generate a monitored activity record for a user;
an activity database configured to hold a plurality of activity records from a plurality of users each activity record having an associated protection level; and
a protection component configured to receive the monitored activity record from the monitoring component and further configured to determine if a current protection level for the computing device is appropriate by identifying at least one activity record in the activity database having an activity pattern similar to the monitored activity record, and further configured to modify the current protection level when the current protection level is different from the protection level associated with the at least one activity record.

2. The protection system of claim 1 wherein the monitoring component is configured to monitor activity passively and to generate the monitored activity report in response to a predetermined event.

3. The protection system of claim 1 wherein the current protection level is assigned on a per user basis.

4. The protection system of claim 1 wherein the protection component is configured to apply a similarity measure to each activity record in the activity database and to the monitored activity.

5. The protection system of claim 4 wherein the similarity measure is a Jacard similarity measure.

6. The protection system of claim 4 wherein the similarity measure is a cosine similarity measure.

7. The protection system of claim 1 wherein the associated protection level is a risk score and wherein the protection component is configured to convert the risk score to a corresponding protection level.

8. The protection system of claim 1 wherein the activity database comprises a plurality of activity records from a plurality of different users of a plurality of different computing devices.

9. The protection system of claim 1 wherein the protection component is configured to request confirmation from the user prior to modifying the current protection level.

10. The protection system of claim 9 wherein the protection component is configured not to request confirmation from the user prior to modifying the current protection level to a higher protection level.

11. A method of monitoring a protection level of a computing device comprising:
setting an initial protection level;
monitoring a user's activity on the computing device;
comparing the user's activity with activity records in an activity database;
identifying at least one activity record in the activity database that is similar to the user's activity;
comparing a protection level of the at least one activity record with the initial protection level; and
modifying the initial protection level when the initial protection level and the protection level of the at least one activity record are different.

12. The method of claim 11 wherein monitoring further comprises:
monitoring the user's activity for over a predefined period of time.

13. The method of claim 11 wherein monitoring further comprises:
detecting a predetermined event type occurring on the computing device; and
capturing the user's activity for a predetermined period of time prior to the detected event.

14. The method of claim 11 wherein monitoring further comprises:
monitoring the user's activity on a random basis.

15. The method of claim 11 wherein comparing further comprises:
applying a similarity measure to each activity record in the activity database.

16. The method of claim 11 wherein modifying further comprises:
automatically raising the initial protection level when the protection level of the at least one activity record is higher than the initial protection level.

17. The method of claim 11 wherein modifying further comprises:
requesting a user input prior modifying the initial protection level.

18. The method of claim 17 wherein requesting only requests the user input when the initial protection level is higher that the protection level of the at least one activity record.

19. The method of claim 11 wherein modifying the initial protection level is constrained by a policy.

20. A method for creating an activity database of activity records and an associated risk score for the activity record, comprising:
receiving at least one activity record from at least one computing device, the activity record representing activity of a user of the at least one computing device;
applying a similarity measure to a plurality of activity records that have been previously stored in the activity database and the at least one received activity record;
identifying at least one activity record in the activity database that is similar to the received activity record;
determining a risk score for the at least one received activity record based in part on a risk score associated with the at least one identified activity record in the activity database; and
storing the received activity record along with the determined risk score in the activity database as a new activity record.
